(19) United States
(12) Patent Application Publication
(10) Pub. No.: US 2002/0060681 A1
(43) Pub. Date: May 23, 2002

(54) Map information providing device, map information providing system, and map information providing method

(76) Inventor: Toshiaki Miyagi, Tokyo (JP)

Correspondence Address: McGinn & Gibb, PLLC, Suite 200, 8321 Old Courthouse Road, Vienna, VA, 22182-3817, US

(21) Appl. No.: 09/987,405

(22) Filed: Nov. 14, 2001

(30) Foreign Application Priority Data
Nov. 17, 2000 (JP) 351426/2000

(51) Int. Cl. G06T 11/20

(52) U.S. Cl. 345/440

(57) ABSTRACT

A map information providing device comprises: a unit for registering a second destination which a map information provider originally selects, in addition to a first destination of a dealer who is under contract with a map information provider to be published on a map, as map information; a unit of checking whether the requested destination is the first destination or the second destination when the map information of a destination is requested by a user terminal device; and a unit of providing the map information free of charge in the case of the first destination, while, in the case of the second destination, notifying the user terminal device of the effect that it is with a charge, so to confirm a user's will to pay for the charge; when acceptance of the payment is confirmed by the user terminal device, performing billing processing and providing the map information, while when refusal of the payment is confirmed by the user terminal device, finishing a connection.

### BACKGROUNDS OF THE INVENTION

1. Field of the Invention

The present invention relates to a map information providing device, a map information providing system, a map information providing method, and a recording medium with a map information providing program recorded therein, and more particularly, it relates to a map information providing system, a map information providing device, a map information providing method, and a recording medium with a map information providing program recorded therein, for providing a user terminal device with map information through a network, especially such as the Internet.

2. Description of the Related Art

Heretofore, when a user wants map information through a network such as the Internet, for example, a user gains access to a home page opened by a map information provider on a network and enters the name of a shop or a company, the address, or the zip code, that is the destination whose map information the user wants, as a retrieval condition from a user terminal device. On the side of a map information providing device, the map information is retrieved according to the entered retrieval condition, and the retrieval result is sent to the user terminal device. Then, the user selects his or her destination from the retrieval result, and the map information of the destination is sent to the user terminal device and displayed there. When a user wants the map information on several destinations, he or she gets the map information of every destination one by one by repeating the above operation. Such a retrieving and providing method of the map information is also disclosed in, for example, Japanese Unexamined Patent Publication (Kokai) No. Heisei 11-212999.

On a map to be provided, apart from the public facilities, there appear only the shops and the companies which make a contract with the map information provider to be published on the map and pay for the contract. Accordingly, the retrieval object is restricted to the above shops and companies paying for the contract fee to the map information provider.

The above conventional technique, however, is defective in a service for a user because the retrieval object in the map information is very restrictive, limited to the shops and companies paying for the contract fee to the map information provider.

When a user wants the map information about several destinations, since the map information is provided one by one as for every destination, the conventional technique cannot display the several destinations on the same map and improve a user's convenience so as to select a destination.

Further, since only a destination is displayed on the map information to be provided, it is defective in that a user's current position, and the positional relation and the distance between a reference point like a user's house and a destination cannot be confirmed on the same map.

### SUMMARY OF THE INVENTION

A first object of the present invention is to provide a map information providing device, a map information providing system, and a map information providing method in which, additionally to the destinations provided free of charge, such as the shops and companies from which the map information provider receives the contract fee, the destinations which the map information provider originally adds are provided with a charge, thereby increasing an income for the map information provider and widening the range of the retrieval objects for a user to find a destination more easily.

A second object of the present invention is to provide a map information providing device, a map information providing system, and a map information providing method which make it easy for a user to find the distance and the positional relation, with several destinations displayed on the same map.

A third object of the present invention is to provide a map information providing device, a map information providing system, and a map information providing method which make it easier for a user to find the distance and the positional relation, with several destinations, a user's current position, and a reference point such as a user's house displayed on the same map.

According to the first aspect of the invention, a map information providing device for providing map information of a destination a user wants, in response to a request from a user terminal device through a network, comprises

means for registering a second destination which a map information provider originally selects, in addition to a first destination of a dealer who is under contract with a map information provider to be published on a map, as map information, and

means for checking whether the requested destination is the first destination or the second destination when the map information of a destination is requested by the user terminal device, as the result, when the destination proves to be the first destination, providing the map information free of charge, while when the destination proves to be the second destination, notifying the user terminal device of the effect that the second destination is with a charge, so to confirm a user's will to pay for the charge, and when acceptance of the payment is confirmed by the user terminal device, performing billing processing and providing the map information, while when refusal of the payment is confirmed by the user terminal device, finishing a connection.

In the preferred construction, the map information providing device further comprises means for checking whether the requested destination is the first destination or the second destination when the map information of a destination is requested by the user terminal device.

In another preferred construction, the map information providing means creates and provides the map information with a mark attached to the corresponding destination when providing the map information.

According to the second aspect of the invention, a map information providing device for providing map information of a destination a user wants, in response to a request from a user terminal device through a network, comprises

means for registering a second destination which a map information provider originally selects, in addition to a first destination of a dealer who is under contract with the map information provider to be published on a map, as map information,

means for checking whether the plurality of destinations include the second destination or not when the map information of a plurality of destinations is requested by the user terminal device,

means for, when the above destinations include at least one and more second destinations as the result of the above check, notifying the user terminal device of the effect that the second destination is with a charge, and confirming a user's will to pay of the charge, and

means for performing billing processing and providing the map information of all the destinations requested when acceptance of the payment is confirmed by the user terminal device, and providing the map information of the destinations other than the second destination when refusal of the payment is confirmed by the user terminal device.

In the preferred construction, the map information providing means further includes a function of creating and providing the map information including all the destinations on the same map when there is a request for two and more destinations requiring the map information.

In another preferred construction, the map information providing means creates and provides the map information with a mark attached to the corresponding destination when providing the map information.

In another preferred construction, the map information providing means further includes a function of creating and providing the map information including all the destinations on the same map when there is a request for two and more destinations requiring the map information, and

creates and provides the map information with a mark attached to the corresponding destination when providing the map information.

According to the third aspect of the invention, a map information providing device for providing map information of a destination a user wants, in response to a request from a user terminal device through a network, comprises

means for registering a second destination which a map information provider originally selects, in addition to a first destination of a dealer who is under contract with the map information provider to be published on a map, as map information,

means for checking whether the plurality of destinations include the second destination or not when the map information of a reference point and a plurality of destinations is requested by the user terminal device,

means for, when the above destinations include at least one and more second destinations as the result of the above check, notifying the user terminal device of the effect that the second destination is with a charge, and confirming a user's will to pay of the charge, and

means for performing billing processing, and creating and providing the map information including all the destinations and a reference point requested on the same map when acceptance of the payment is confirmed by the user terminal device, and creating and providing the map information including the reference point and the destinations other than the second destination on the same map when refusal of the payment is confirmed by the user terminal device.

In the preferred construction, the map information providing means creates the map information with a mark attached to the corresponding destination and reference point when creating the map information.

According to another aspect of the invention, a map information providing system having a user terminal device, a map information providing device for providing map information of a destination a user wants, in response to a request from the user terminal device, and the Internet for connecting them with each other, in which

the user terminal device comprises

means for gaining access to a home page opened on the Internet by a map information provider, means for entering and sending a retrieval condition of a destination on the home page, selecting a desired destination from the received destination candidates, and sending the same destination so as to request its map information from the map information provider, and

means for receiving and displaying the home page information and the map information, while

the map information providing device comprises

means for registering a second destination which the map information provider originally selects, in addition to a first destination of a dealer who is under contract with the map information provider to be published on a map, as map information,

means for retrieving the map information according to the retrieval condition received from the user terminal device and sending the destination candidate list information to the user terminal device,

means for checking whether the requested destination is the first destination or the second destination when the map information of the selected destination is requested by the user terminal device, and

means for providing the map information free of charge when the destination proves to be the first destination as the result of the above check, notifying the user terminal device of the effect that the second destination is with a charge, so to confirm a user's will to pay for the charge when the destination proves to be the second destination, when acceptance of the payment is confirmed by the user terminal device, performing billing processing and providing the map information, while when refusal of the payment is confirmed by the user terminal device, finishing a connection.

In the preferred construction, the map information providing means creates and provides the map information with a mark attached to the corresponding destination when providing the map information.

According to another aspect of the invention, a map information providing system having a user terminal device, a map information providing device for providing map information of a destination a user wants, in response to a request from the user terminal device, and the Internet for connecting them with each other, in which

the user terminal device comprises

means for gaining access to a home page opened on the Internet by a map information provider,

means for repeating, several times, an operation of entering and sending a retrieval condition of a destination on the home page and selecting a desired destination from the received destination candidate list information, and storing the selected destinations every time,

means for requesting the map information of the several destinations stored in the above from the map information provider, and

means for receiving and displaying the home page information and the map information, while

the map information providing device comprises

means for registering a second destination which the map information provider originally selects, in addition to a first destination of a dealer who is under contract with the map information provider to be published on a map, as map information,

means for retrieving the map information according to the retrieval condition received from the user terminal device and sending the destination candidate list information to the user terminal device,

means for checking whether the several destinations include the second destination or not when the map information of the several destinations is requested by the user terminal device,

means for, when the above destinations include at least one and more second destinations as the result of the above check, notifying the user terminal device of the effect that the second destination is with a charge, and confirming a user's will to pay of the charge, and

means for performing billing processing and providing the map information of all the requested destinations when acceptance of the payment is confirmed by the user terminal device, and providing the map information of the destinations other than the second destination when refusal of the payment is confirmed by the user terminal device.

In the preferred construction, the map information providing means creates and provides the map information with a mark attached to the corresponding destination when providing the map information.

In another preferred construction, the map information providing means of the map information providing device further includes a function of creating and providing the map information including all the destinations on the same map when there is a request for two and more destinations requiring the map information, and

creates and provides the map information with a mark attached to the corresponding destination when providing the map information.

According to another aspect of the invention, a map information providing system having a user terminal device, a map information providing device for providing map information of a destination a user wants, in response to a request from the user terminal device, and the Internet for connecting them with each other, in which

the user terminal device comprises

means for gaining access to a home page opened on the Internet by a map information provider,

means for repeating, several times, an operation of entering and sending a retrieval condition of a destination on the home page and selecting a desired destination from the received destination candidate list information, and storing the selected destinations every time,

means for entering and sending a retrieval condition of a reference point on the home page, selecting a desired reference point from the received reference point candidate list information, and storing the same reference point,

means for requesting the map information of the several destinations and the reference point stored in the above from the map information provider, and

means for receiving and displaying the home page information and the map information, while

the map information providing device comprises

means for registering a second destination which the map information provider originally selects, in addition to a first destination of a dealer who is under contract with the map information provider to be published on a map, as map information,

means for retrieving the map information according to the retrieval condition received from the user terminal device and sending the destination candidate list information and the reference point candidate list information to the user terminal device,

means for checking whether the several destinations include the second destination or not when the map information of the reference point and the several destinations is requested by the user terminal device,

means for, when the above destinations include at least one and more second destinations as the result of the above check, notifying the user terminal device of the effect that the second destination is with a charge, and confirming a user's will to pay of the charge, and

means for performing billing processing, and creating and providing the map information including all the requested destinations and reference point on the same map when acceptance of the payment is confirmed by the user terminal device, and creating and providing the map information including the reference point and the destinations other than the second destination on the same map when refusal of the payment is confirmed by the user terminal device.

In the preferred construction, the map information providing device creates the map information with a mark attached to the corresponding destination and reference point when creating the map information.

According to another aspect of the invention, a map information providing method in which a map information providing device provides map information of a destination a user wants, in response to a request from a user terminal device, comprising the following steps of

registering pay destinations and free destinations into the map information providing device in advance,

checking whether the requested destination is free of charge or with a charge when the map information of a destination is requested by the user terminal device,

providing the map information free of charge when the destination proves to be free as the result of the check,

notifying the user terminal device of this effect when the destination proves to be with a charge and confirming a user's will to pay for the charge, and

performing billing processing and providing the map information when a user accepts the payment, while finishing a connection when a user refuses the payment.

According to another aspect of the invention, a map information providing method in which a map information providing device provides map information of a destination a user wants, in response to a request from a user terminal device, comprising the following steps of

registering pay destinations and free destinations into the map information providing device in advance,

checking whether the several destinations include the pay destination when the map information of several destinations is requested by the user terminal device,

notifying the user terminal device of this effect when the destinations include at least one and more pay destinations as the result of the check and confirming a user's will to pay for the charge, and

performing billing processing when a user accepts the payment and creating and providing the map information including all the requested destinations on the same map, while

creating and providing the map information including the destinations other than the pay destination on the same map when a user refuses the payment.

According to another aspect of the invention, a map information providing method in which a map information providing device provides map information of a destination a user wants, in response to a request from a user terminal device, comprising the following steps of

registering pay destinations and free destinations into the map information providing device in advance,

checking whether the several destinations include the pay destination when the map information of a reference point and several destinations is requested by the user terminal device,

notifying the user terminal device of this effect when the destinations include at least one and more pay destinations as the result of the check and confirming a user's will to pay for the charge, and

performing billing processing when a user accepts the payment, and creating and providing the map information including all the requested destinations and reference point on the same map, while

creating and providing the map information including the reference point and the destinations other than the pay destination on the same map when a user refuses the payment.

According to a further aspect of the invention, a map information providing program, which works a computer, for providing the map information of a destination a user wants, in response to a request from a user terminal device, comprising the functions of

a function of registering a second destination which a map information provider originally selects, in addition to a first destination of a dealer who is under contract with a map information provider to be published on a map, as map information,

a function of checking whether the requested destination is the first destination or the second destination when the map information of a destination is requested by the user terminal device, and

a function of providing the map information free of charge when the destination proves to be the first destination as the result of the above check, and notifying the user terminal device of the effect that the second destination is with a charge, so to confirm a user's will to pay for the charge when the destination proves to be the second destination, when acceptance of the payment is confirmed by the user terminal device, performing billing processing and providing the map information, while when refusal of the payment is confirmed by the user terminal device, finishing a connection.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a block diagram showing a structure according to a first embodiment and a second embodiment of the present invention;

FIG. 2 is a flow chart showing an operation according to the first embodiment of the present invention;

FIG. 3 is a flow chart showing an operation according to the second embodiment of the present invention;

FIG. 4 is a block diagram showing a structure according to a third embodiment;

FIG. 5 is a flow chart showing a registration operation of a reference point in the third embodiment of the present invention;

FIG. 6 is a flow chart showing an operation according to the third embodiment of the present invention;

FIG. 7 is a block diagram showing a structure according to a fourth embodiment and a fifth embodiment of the present invention;

FIG. 8 is a block diagram showing a structure according to a sixth embodiment of the present invention.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

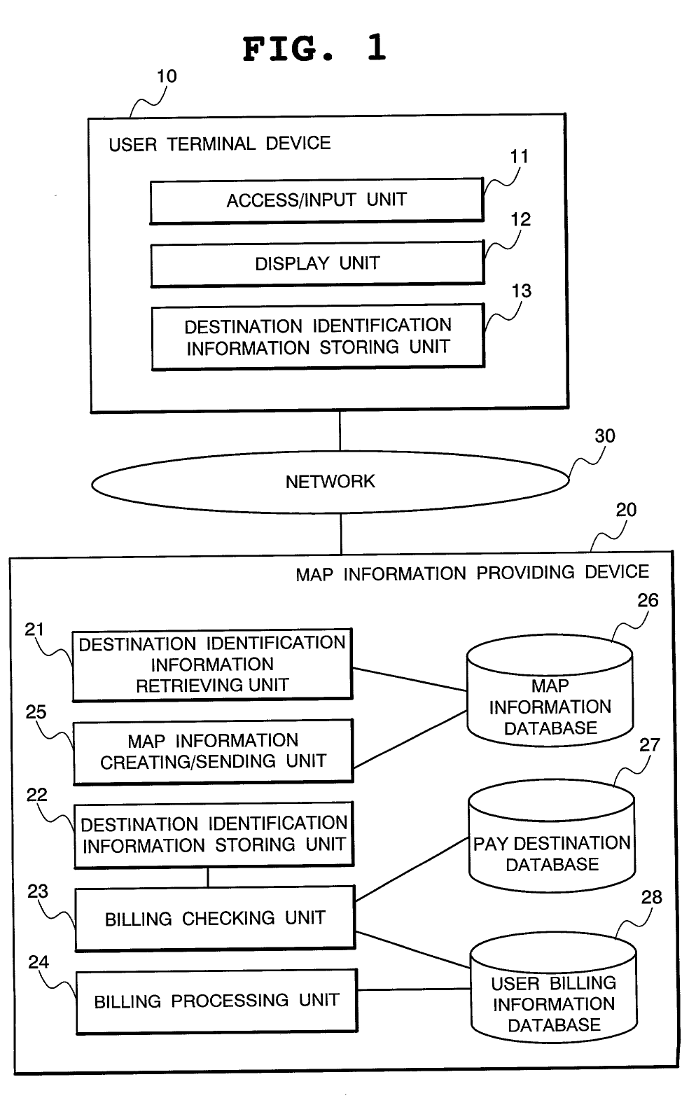

At first, the first embodiment of the present invention will be described. FIG. 1 is a block diagram showing a structure according to the first embodiment and the second embodiment.

Referring to FIG. 1, the first embodiment of the present invention comprises a user terminal device 10, a map information providing device 20, and a network 30 such as the Internet for connecting both with each other.

The user terminal device 10 is an information processing device, for example, like a personal computer, which comprises an access/input unit 11 such as a keyboard or a pointing device for entering necessary information through access to the map information providing device 20, a display unit 12 such as a liquid crystal display for receiving and displaying the information sent from the map information providing device 20, and a destination identification information storing unit 13 for temporarily storing the identification information of a destination a user selects from retrieved list information.

The map information providing unit 20 is an information processing device, for example, such as a workstation server, which comprises a destination identification information retrieving unit 21, a destination identification information storing unit 22, a billing checking unit 23, a billing processing unit 24, a map information creating/sending unit 25, a map information database 26, a pay destination database 27, and a user billing information database 28.

The destination identification retrieving unit 21 retrieves the identification information of a destination from the map information database 26 according to a retrieval condition of the destination sent from the user terminal device 10. The retrieval condition sent from the user terminal device 10 may be specified, for example, by a single item of the name (company name, shop name, and the like), address, zip code, area, and business type, or by a combination of some items (a combination of xx department store and Tokyo or a combination of Indian restaurant and Sinjuku). The identification information of a destination retrieved according to the above retrieval condition is the information including, for example, the name of a destination, the address, and the telephone number. When xx department store Ginza, Shibuya, and Ikebukuro are found as the result of retrieval according to the retrieval condition of xx department store and Tokyo, the name, the address, and the telephone number of each shop are sent to the user terminal device 10 as the identification information of the retrieval result.

The destination identification information storing unit 22 receives and stores the identification information of the destination a user selects after the identification information of the retrieval result is sent to the user terminal device 10 by the destination identification information retrieving unit 21.

The billing checking unit 23 retrieves the pay destination database 27 based on the identification information of the destination a user selects, and checks whether the destination is a pay destination or a free destination. When it is a pay destination, it retrieves the user billing information database 28 based on a user ID number received from the user terminal device 10, so to check whether or not this user is under a contract of monthly fixed charge, thereby deciding whether the map display this time should be charged or not. The free destination means the public facilities and the shops and companies paying for the contract fee, while the pay destination means the destination a map information provider originally adds to a map.

The billing processing unit 24 bills a user under a contract of monthly fixed charge once a month (for example, at the end of a month), and bills some other user for a predetermined charge every time providing him or her with the map information of a pay destination. In this case, a charge may be fixed, depending on the number of the pay destinations or regardless of the number of the pay destinations. The details of the payment from a user's account of a financial institute are well known, and the description thereof is omitted because it is not the purpose of the present invention.

The map information creating/sending unit 25 retrieves the map information database 26 according to the identification information of the destination sent from the user terminal device 10, to receive the map information corresponding to the destination, and provides it to the user terminal device 10.

The map information database 26 stores map image data in correspondence with the map number and the coordinate number, as the map information, and stores the name of each pay destination and free destination displayed on a map, in correspondence with the items of address, zip code, area, and business type, as well as with the map number and the coordinate number. As the map image data, that one including the pay destinations (the destinations a map information provider originally adds to a map) and the free destinations (public facilities, and the shops and companies paying for the contract fee) is created and stored in the map information database 26.

The pay destination database 27 stores the identification information of the pay destinations (the name of a destination, the address, the telephone number, and the like). This information is decided by a map information provider and registered into the pay destination database 27 in advance. On the contrary to the free destinations that are the shops and the companies with which a map information provider makes a contact to be published on a map and which pay for the contract fee, the pay destinations are destinations which a map information provider originally adds to a map, without making a contact with anyone or without income of the contract fee, and instead, a charge of use can be collected from a user when providing the user with the map information of a pay destination. Thus, a map information provider can improve income and a user can find his or her destination more easily in the wider range of the retrieval objects.

The user billing information database 28 stores the respective billing information corresponding to the user ID number for every user. The billing information means the information whether or not the billing for a user's receiving the map information of a pay destination is under a contract of monthly fixed charge and the settlement information including the account number of a financial institution and the amount of a bill.

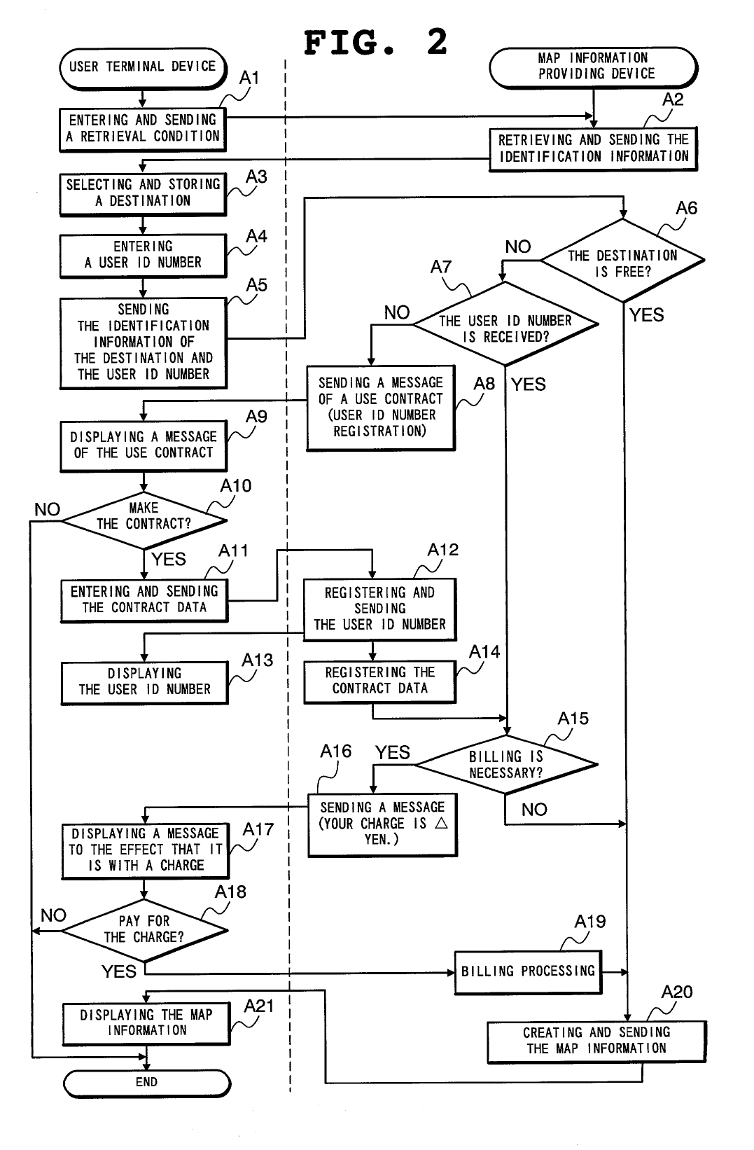

This time, an operation according to the first embodiment of the present invention will be described with reference to FIG. 1 and FIG. 2. FIG. 2 is a flow chart showing the operation of the first embodiment of the present invention. In the following description, assume that the network 30 is the Internet.

A user gains access to the home page opened by a map information provider on the network 30 from the access/input unit 11 and enters the retrieval condition of a destination whose map information a user wants to display (Step A1 of FIG. 2).

The destination identification information retrieving unit 21 of the map information providing device 20 receives the retrieval condition entered in Step A1, retrieves the identification information of the destination from the map information database 26 according to the retrieval condition, and sends the list information of the retrieval result to the user terminal device 10 (Step A2).

A user selects the destination he or she wants, from the list information of the received retrieval result, through the access/input unit 11 of the user terminal device 10, and stores the selected identification information into the destination identification information storing unit 13 (Step A3). When the selection of the destination is finished, the user enters the user ID number through the access/input unit 11 (Step A4) and pushes, for example, a complete button on the home page, hence to send the identification information of the destination stored in the destination identification information storing unit 13 in Step A3 and the user ID number entered in Step A4 to the map information providing device 20, before deleting the identification information of the destination identification information storing unit 13 (Step A5). Since the user ID number is the number to be given to every user after a billing contract with a user to receive a map information service of the pay destinations, a user who is not under the contract cannot enter anything at this time. Therefore, on the home page, there is displayed a message to the effect that a user who has not made a billing contract to receive the map information service of the pay destinations doesn't have to enter the user ID number.

The billing checking unit 23 of the map information providing device 20 temporarily stores the identification information of the received destination into the destination identification information storing unit 22, and retrieves the pay destination database 27 to check whether the identification information of the received destination corresponds to a pay destination. Then, it stores the destination identification information with specification of a free destination or a pay destination, into the destination identification storing unit 22 (Step A6).

When the destination proves to be a pay destination as the retrieval result in Step A6, the billing checking unit 23 confirms whether the user ID number has been sent from the user terminal device 10 (Step A7), and when it is a free destination, this step will be advanced to Step A20.

When it proves that the user ID number has been sent in Step A7, this step will be advanced to Step A15, while when it has not been sent, contract screen information for the map information service of the pay destinations is sent to the user terminal device 10 (Step A8).

The contract screen information is displayed on the user terminal device 10, and there is displayed a message to the effect that a billing contract is necessary because the destination a user selects is a pay destination (Step A9). This induces a user to select whether or not to make a billing contract to receive the map information service of the pay destinations (Step A10).

When a user selects that he or she doesn't make a billing contract in Step A10, the user enters the contract data through the access/input unit 11 (Step A11). The contract data means the information whether billing for receiving a map information service of the pay destinations is under a contract of a monthly fixed charge and the settlement information including the account number of a financial institution for drawing a charge.

The billing checking unit 23 creates a user ID number newly by receiving the contract data from the user terminal device 10 and sends the same number to the user terminal device 10 (Step A12). The user terminal device 10 displays the sent user ID number (Step A13), thereby enabling a user to use this user ID number at the next access to the map information providing device 20 and the later.

Continuously to Step A12, the billing checking unit 23 registers the contract data sent from the user terminal device 10 into the user billing information database 28 in correspondence with the user ID number (Step A14).

Thereafter, the billing checking unit 23 checks the necessity of billing, referring to the contract data including the information whether the billing for receiving the map information service of the pay destinations is under a contract of a monthly fixed charge (Step A15). In the case of the contract of the monthly fixed charge, it decides that the billing is not necessary because it should not be required every time, and this step is advanced to Step A20. On the other hand, when the billing is not under a contract of a monthly fixed charge, it decides that the billing is necessary because it should be required every time, and sends a message to the effect that you are charged, for example, your charge is ΔΔ yen, to the user terminal device 10 (Step A16).

The user terminal device 10 displays the message to the effect that you will be charged (Step A17), and a user enters whether he or she pays for the charge or not (Step A18). When the user selects No in Step A18, the connection is broken; when the user selects Yes, the billing checking unit 23 registers a predetermined charge in the user billing information database, as the data on the amount of a bill corresponding to the user ID number of this user, and passing the user ID number to the billing processing unit 24, asks the unit 24 for the billing processing. The billing processing unit 24 performs the billing processing for drawing a charge from a user's account with reference to the user billing information database 28 (Step A19). Since this drawing processing of a charge from a user's account of a financial institution is well known and it is not the purpose of the present invention, the detailed description is omitted here.

The map information creating/sending unit 25 retrieves the map information of a destination from the map information database according to the identification information of the destination temporarily stored in the destination identification information storing unit 22, continuously to Steps A6, A15, and A19, sends it to the user terminal device 10, and thereafter, deletes the identification information of the destination temporarily stored in the destination identification information storing unit 22 (Step A20). The user terminal device 10 displays the map information of the destination on the display unit 12 (Step A21).

The second embodiment of the present invention will be described in detail with reference to the drawings.

This embodiment is different from the first embodiment of the present invention in that a plurality of destinations are displayed on the same map. In the first embodiment, since each destination is displayed one by one, if a user selects no payment for the charge of a pay destination, the connection will be broken. In the second embodiment, however, if a user selects no payment for the charge, the map information excluding the pay destinations from a plurality of destinations will be provided, differently from the first embodiment.

The structure of the second embodiment is almost the same as that of the first embodiment shown in FIG. 1. In detail, however, the following points are added to the map information creating/sending unit 25 and the map information database 26.

When a user selects no payment for the charge of a pay destination, the map information creating/sending unit 25 provides the user terminal device 10 with the map information excluding the display of the pay destinations. As described later, the pay destinations are distinguishable from the free destinations, for example, in the color of display and the form of a character. Accordingly, the data corresponding to the above can be deleted distinguishably, thereby providing the user terminal device 10 with the map information excluding the pay destinations.

The map information creating/sending unit 25 includes processing means (function) for retrieving each map number or each map coordinate number of the respective map information in the identification information of a plurality of destinations from the map information database and calculating each map number or map coordinate number including all the map information. For example, when the map coordinate number of the first destination is X2/Y3 and the map coordinate number of the second destination is X4/Y5, it derives X2 to X4/Y3 to Y5. Therefore, the unit 25 sends the map information of a rectangular area ranging from X2 to X4 in the horizontal axis and from Y3 to Y5 in the vertical axis to the user terminal device 10, and a user can see the map information including both the first and the second destinations.

The map information database 26 creates and stores the map information including both the pay destinations and the free destinations, and the pay destinations are displayed in a distinguishable way from the free destinations, for example, in the color of display and the form of a character.

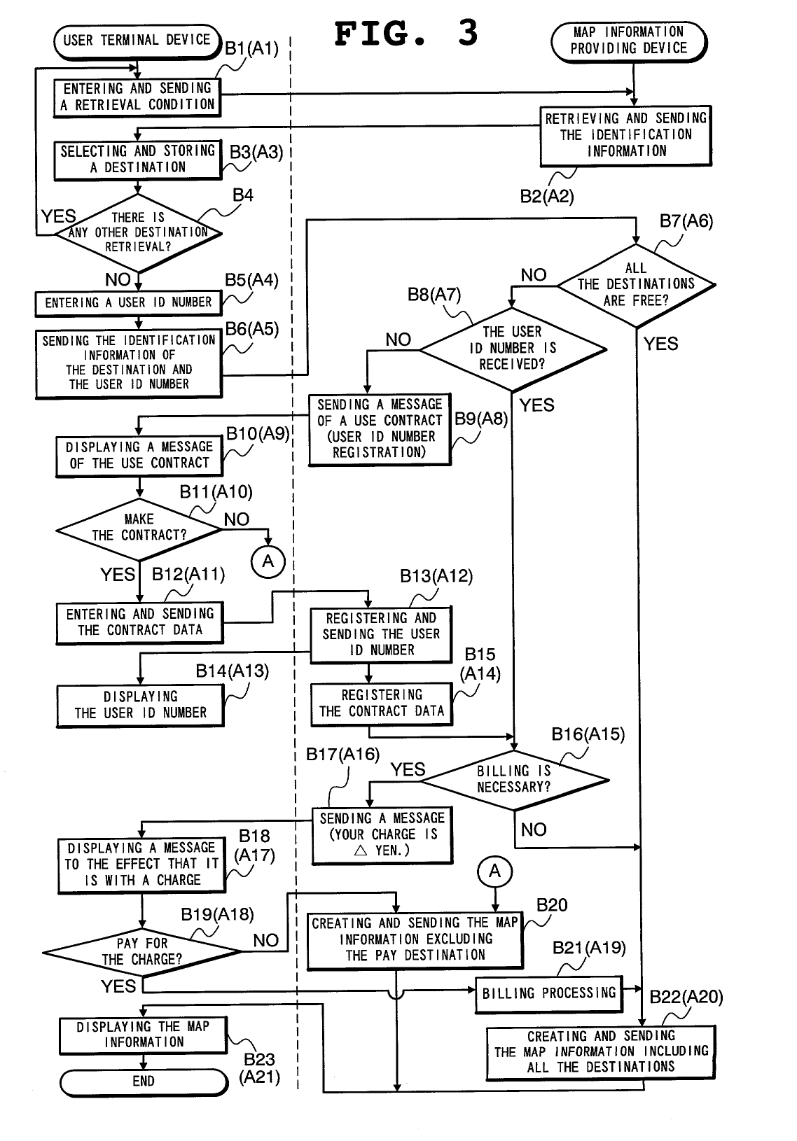

The operation of the second embodiment of the present invention will be described with reference to FIGS. 1 to 3. FIG. 3 is a flow chart showing the operation of the second embodiment of the present invention. The operation of the second embodiment in FIG. 3 is different from that of the first embodiment in FIG. 2 in that in FIG. 3, Step B4 and Step B20 are added to FIG. 2. The others are almost the same. For the sake of preventing the overlap of the description, the different portions are described here. The reference marks (A1), (A2), and the like in FIG. 3 indicate the respective steps corresponding to those in FIG. 2, and for example, the case of B1 (A1) shows that Step B1 in FIG. 3 corresponds to Step A1 in FIG. 2.

In the added Step B4, whether or not there is any other destination to be retrieved is checked. If there is, the operation of Steps B1 to B3 (corresponding to Steps A1 to A3 in FIG. 2) is repeated. Thus, the identification information of several destinations selected is stored in the destination identification storing unit 13.

In Step B7, whether all the received destinations are out of charge or not is checked, and if there is even only one pay destination, this step will be advanced to Step B8.

In Step B20, the map information creating/sending unit 25 creates the map information excluding the pay destinations and sends the same information to the user terminal device 10 when a user answers that he or she doesn't make a contract for use in Step B11 or when a user answers that he or she doesn't pay for the charge in Step B19. At this time, the map information creating/sending unit 25 retrieves each map number or each map coordinate number of the respective map information from the map information database 26, out of the identification information of the free destinations stored in the destination identification information storing unit 22, calculates the map numbers or the map coordinate numbers including all the map information, and receives the map information including all the free destinations from the map information database 26. For example, by deleting the data indicated in the color of display or the form of a character used for displaying the pay destinations, from the map information, the map information excluding the pay destinations is created.

In Step B22, the map information creating/sending unit 25 creates the map information excluding all the destinations and sends the same information to the user terminal device 10. At this time, the map information creating/sending unit 25 retrieves each map number or each map coordinate number of the respective map information from the map information database 26, out of the identification information of the pay destinations and the free destinations stored in the destination identification information storing unit 22, calculates the map numbers or the map coordinate numbers including all the map information, receives the map information including all the destinations from the map information database 26, and sends the same information to the user terminal device 10.

The third embodiment of the present invention will be described in detail with reference to the drawings.

This embodiment is different from the second embodiment of the present invention in that the information of a reference point such as a user's house and a user's current position is further added and that the reference point and one or several destinations are displayed on the same map.

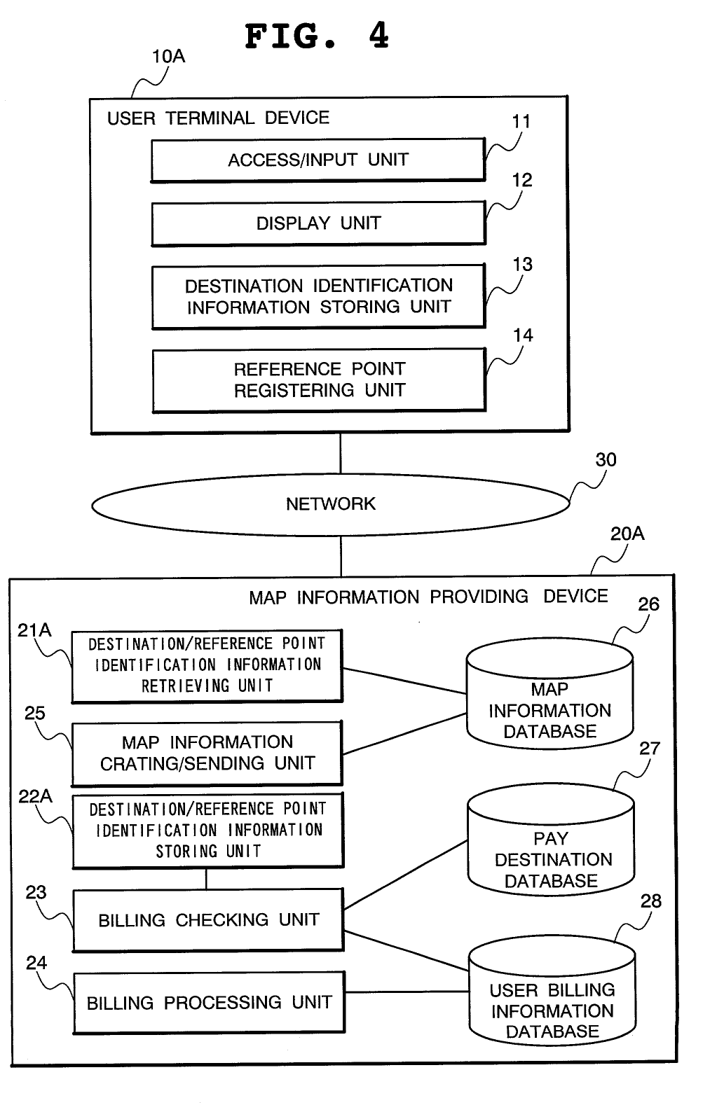

FIG. 4 is a block diagram showing a structure of the third embodiment. The structure of this embodiment is different from the first embodiment shown in FIG. 1 in that a reference point registering unit 14 is further added to the user terminal device 10 of FIG. 1. According to this, the information of the reference point is respectively added to the destination identification information retrieving unit 21 and the destination identification information storing unit 22 of FIG. 1, which are changed to the destination/reference point identification information retrieving unit 21A and the destination/reference point identification storing unit 22A.

An operation according to the third embodiment of the present invention will be described with reference to FIGS. 4 to 6 and FIG. 3.

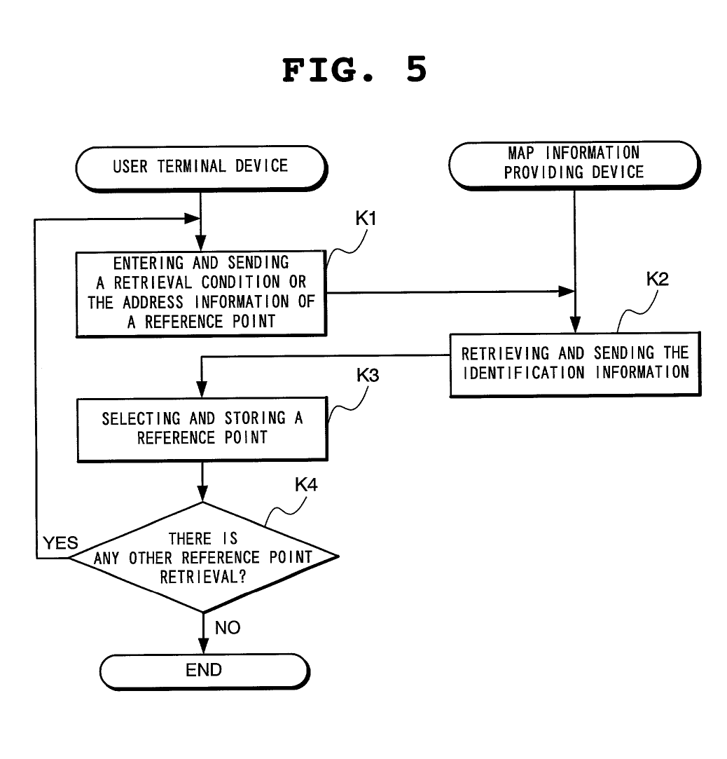

At first, the registering operation of a reference point will be described in detail with reference to FIG. 5. FIG. 5 is a flow chart showing the registering operation of a reference point in the third embodiment of the present invention.

A user gains access to the home page opened by a map information provider on the network 30, through the access/input unit 11 from the user terminal device 10A and enters the address information or the retrieval condition of the reference point whose map information the user wants to display (Step K1 of FIG. 5).

The destination/reference point identification information retrieving unit 21A of the map information providing device 20A receives the address information or the retrieval condition entered in Step K1, retrieves the identification information of a reference point from the map information database 26 according to this address information or retrieval condition, and sends the list information of the retrieval result to the user terminal device 10A (Step K2).

A user selects a reference point he or she wants from the list information of the received retrieval result, through the access/input unit 11 of the user terminal device 10A, and stores the selected identification information into the reference point registering unit 14 (Step K3).

Thereafter, if there is a reference point the user wants to register, Step K1 to Step K3 will be repeated (Step K4).

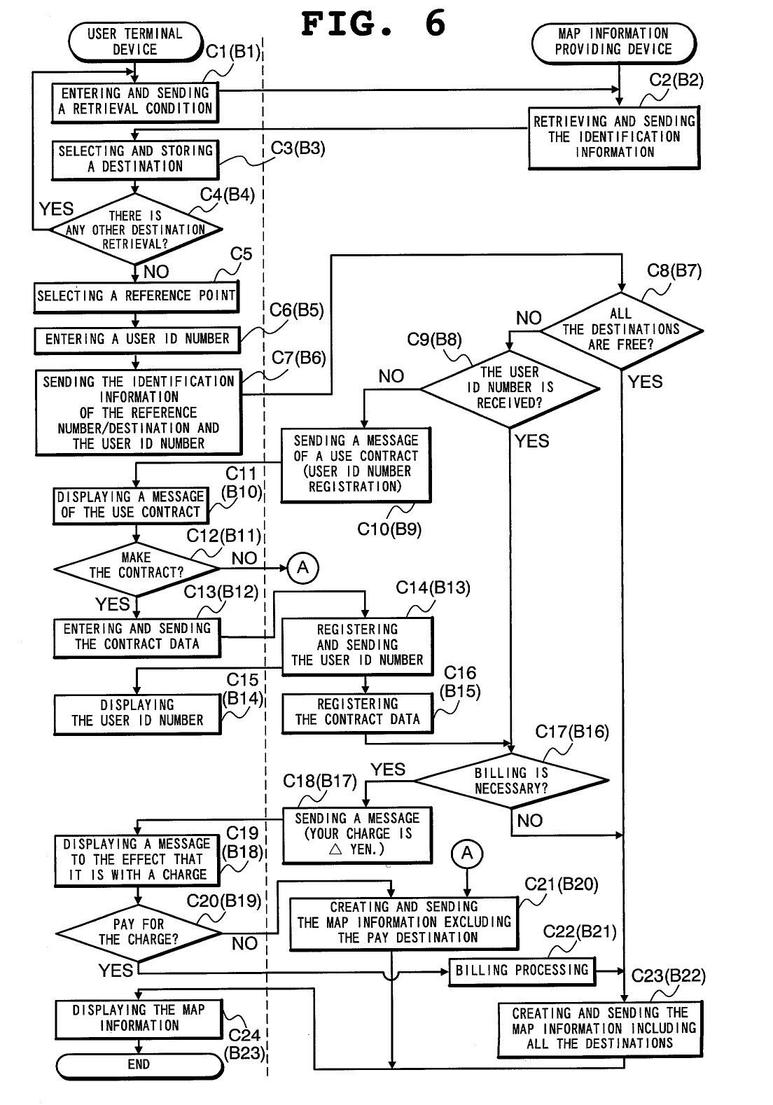

This time, the operation of the third embodiment of the present invention will be described in detail with reference to FIG. 4 to FIG. 6. FIG. 6 is a flow chart showing the operation of the third embodiment of the present invention.

The operation of the third embodiment in FIG. 6 is different from the operation of the second embodiment in FIG. 3 in that, in FIG. 6, Step C5 is added to FIG. 3. The others are almost the same and therefore, in FIG. 6, only the portion different from that of FIG. 3 will be described. The reference marks (B1), (B2), and the like in FIG. 6 indicate the respective steps corresponding to those in FIG. 3, and for example, the case of C1(B1) indicates that Step C1 in FIG. 6 corresponds to Step B1 in FIG. 3.

In the added Step C5, the identification information of a reference point a user wants is selected from the identification information of the reference points previously registered in the reference point registering unit 14 by the registering operation shown in FIG. 5. Thereafter, the user ID number is entered in Step C6, and the reference point, the identification information of the destination, and the user ID number are sent to the map information providing device 20A in Step C7.

In creating the map information in Step C21 and C23, the map information creating/sending unit 25 creates the map information including both the reference point and the destination.

The fourth embodiment of the present invention will be described in detail with reference to the drawings.

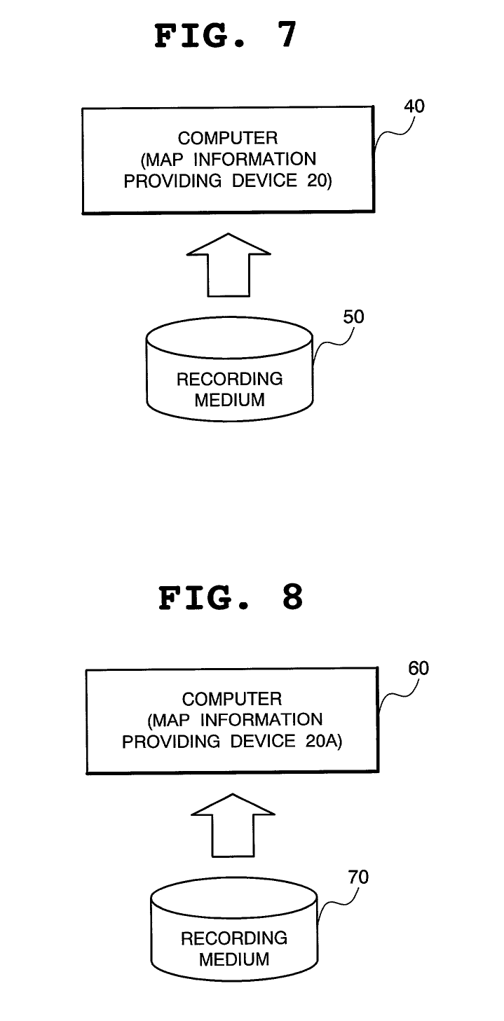

FIG. 7 is a block diagram showing a structure of the fourth embodiment of the present invention, which comprises a computer 40 and a recording medium 50. The structure of the computer 40 is fundamentally the same as that of the map information providing device 20 of FIG. 1 described in the first embodiment of the present invention. The recording medium 50 stores a map information providing program. The recording medium 50 may be realized by a magnetic disk, an optical recording disk, a semiconductor memory, or the other recording medium. The map information providing program is read by the computer 40 from the recording medium 50, and the same operation as that of the first embodiment of the present invention can be realized by controlling the computer 40.

The fifth embodiment of the present invention will be described in detail with reference to the drawings.

FIG. 7 is a block diagram showing a structure of the fourth and the fifth embodiments of the present invention, which comprises the computer 40 and the recording medium 50. The structure of the computer 40 is fundamentally the same as that of the map information providing device 20 of FIG. 1 described in the second embodiment of the present invention. The recording medium 50 stores the map information providing program. The recording medium 50 may be realized by a magnetic disk, an optical recording disk, a semiconductor memory, or the other recording medium. The map information providing program is read by the computer 40 from the recording medium 50, and the same operation as that of the second embodiment of the present invention can be realized by controlling the computer 40.

The sixth embodiment of the present invention will be described in detail with reference to the drawings.

FIG. 8 is a block diagram showing a structure of the sixth embodiment of the present invention, which comprises a computer 60 and a recording medium 70. The structure of the computer 60 is fundamentally the same as that of the map information providing device 20A of FIG. 4 described in the third embodiment of the present invention. The recording medium 70 stores a map information providing program. The recording medium 70 may be realized by a magnetic disk, an optical recording disk, a semiconductor memory, or the other recording medium. The map information providing program is read by the computer 60 from the recording medium 70, and the same operation as that of the third embodiment of the present invention can be realized by controlling the computer 60.

In the above-mentioned first to sixth embodiments, although the pay destination database 27 is provided separately from the map information database 26, the pay destination database 27 may be deleted, and the information of the pay destinations and the free destinations may be attached to the identification information of the map information database 26.

In the above-mentioned first to sixth embodiments, the registration of the user ID number may be performed as soon as a user gains access to the home page from the user terminal device 10.

In the above-mentioned first to sixth embodiments, although any mark (marking) is not attached to the destinations and the reference points on the map information, the map information creating/sending unit 25 may be provided with means (function) of attaching the marking data to the map information, thereby providing the map information convenient for a user to see.

Further, in the above-mentioned second, third, fifth, and sixth embodiments, the map information including the free destinations and the pay destinations distinguishable from each other in the color of display and the form of a character is created and stored as the map information in the map information database 26, and the map information creating/sending unit 25 controls the delete of the data about the pay destinations. Otherwise, two kinds of the map information; one including both the data of the pay destinations and the free destinations and the other excluding the data of the pay destinations may be stored in the map information database 26, although its capacity becomes large, and the map information creating/sending unit 25 may select one of them.

In the above-mentioned second, third, fifth, and sixth embodiments, the retrieval whether a destination is the pay destination or the free destination may be also performed in Step B2 of FIG. 3 and in Step C2 of FIG. 6, and when a user selects a destination in Step B3 of FIG. 3 and Step C3 of FIG. 6 and the destination is the pay destination, a message to this effect may be displayed, so as to inform it to a user in advance.

In the description of the above-mentioned third and sixth embodiments, although the registration of a reference point is performed in advance, as illustrated in FIG. 5, the retrieval of a reference point may be performed every time continuously to the destination retrieval of FIG. 6, instead of selecting one from the reference points previously registered like in Step C5 of FIG. 6.

According to the present invention, not only the destinations of the shops and the companies from which a map information provider receives the contract fee, are provided free of charge, but also the destinations the map information provider originally adds, are provided with a charge. Therefore, it is effective in that a map information provider can expect an increasing income and that a user can find a destination more easily according to the wider range of the retrieval objects.

According to the present invention, since a plurality of destinations are displayed on the map, it is effective in that a user can grasp the distance and positional relation more easily.

According to the present invention, since a plurality of destinations, a user's current position, and a reference point such as a user's house are displayed on the same map, it is effective in that a user can grasp the distance and positional relation more easily.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A map information providing device for providing map information of a destination a user wants, in response to a request from a user terminal device through a network, comprising:
means for registering a second destination which a map information provider originally selects, in addition to a first destination of a dealer who is under contract with a map information provider to be published on a map, as map information; and
means for checking whether the requested destination is the first destination or the second destination when the map information of a destination is requested by the user terminal device, as the result, when the destination proves to be the first destination, providing the map information free of charge, while when the destination proves to be the second destination, notifying the user terminal device of the effect that the second destination is with a charge, so to confirm a user's will to pay for the charge, and when acceptance of the payment is confirmed by the user terminal device, performing billing processing and providing the map information, while when refusal of the payment is confirmed by the user terminal device, finishing a connection.

2. The map information providing device as set forth in claim 1, further comprising
means for checking whether the requested destination is the first destination or the second destination when the map information of a destination is requested by the user terminal device.

3. The map information providing device as set forth in claim 1, wherein
said map information providing means creates and provides the map information with a mark attached to the corresponding destination when providing the map information.

4. A map information providing device for providing map information of a destination a user wants, in response to a request from a user terminal device through a network, comprising:
means for registering a second destination which a map information provider originally selects, in addition to a first destination of a dealer who is under contract with the map information provider to be published on a map, as map information;
means for checking whether the plurality of destinations include the second destination or not when the map information of a plurality of destinations is requested by the user terminal device;
means for, when the above destinations include at least one and more second destinations as the result of the above check, notifying the user terminal device of the effect that the second destination is with a charge, and confirming a user's will to pay of the charge; and
means for performing billing processing and providing the map information of all the destinations requested when acceptance of the payment is confirmed by the user terminal device, and providing the map information of the destinations other than the second destination when refusal of the payment is confirmed by the user terminal device.

5. The map information providing device as set forth in claim 4, wherein
said map information providing means further includes a function of creating and providing the map information including all the destinations on the same map when there is a request for two and more destinations requiring the map information.

6. The map information providing device as set forth in claim 4, wherein
said map information providing means creates and provides the map information with a mark attached to the corresponding destination when providing the map information.

7. The map information providing device as set forth in claim 4, wherein
said map information providing means further includes a function of creating and providing the map information including all the destinations on the same map when there is a request for two and more destinations requiring the map information, and
creates and provides the map information with a mark attached to the corresponding destination when providing the map information.

8. A map information providing device for providing map information of a destination a user wants, in response to a request from a user terminal device through a network, comprising:
means for registering a second destination which a map information provider originally selects, in addition to a first destination of a dealer who is under contract with the map information provider to be published on a map, as map information;
means for checking whether the plurality of destinations include the second destination or not when the map information of a reference point and a plurality of destinations is requested by the user terminal device;
means for, when the above destinations include at least one and more second destinations as the result of the above check, notifying the user terminal device of the effect that the second destination is with a charge, and confirming a user's will to pay of the charge; and
means for performing billing processing, and creating and providing the map information including all the destinations and a reference point requested on the same map when acceptance of the payment is confirmed by the user terminal device, and creating and providing the map information including the reference point and the destinations other than the second destination on the same map when refusal of the payment is confirmed by the user terminal device.

9. The map information providing device as set forth in claim 8, wherein
said map information providing means creates the map information with a mark attached to the corresponding destination and reference point when creating the map information.

10. A map information providing system having a user terminal device, a map information providing device for providing map information of a destination a user wants, in response to a request from the user terminal device, and the Internet for connecting them with each other, in which
the user terminal device comprising:
means for gaining access to a home page opened on the Internet by a map information provider;
means for entering and sending a retrieval condition of a destination on the home page, selecting a desired destination from the received destination candidates, and sending the same destination so as to request its map information from the map information provider; and
means for receiving and displaying the home page information and the map information, while
the map information providing device comprising:
means for registering a second destination which the map information provider originally selects, in addition to a first destination of a dealer who is under contract with the map information provider to be published on a map, as map information;
means for retrieving the map information according to the retrieval condition received from the user terminal device and sending the destination candidate list information to the user terminal device;
means for checking whether the requested destination is the first destination or the second destination when the map information of the selected destination is requested by the user terminal device; and
means for providing the map information free of charge when the destination proves to be the first destination as the result of the above check, notifying the user terminal device of the effect that the second destination is with a charge, so to confirm a user's will to pay for the charge when the destination proves to be the second destination, when acceptance of the payment is confirmed by the user terminal device, performing billing processing and providing the map information, while when refusal of the payment is confirmed by the user terminal device, finishing a connection.

11. The map information providing system as set forth in claim 10, wherein
said map information providing means creates and provides the map information with a mark attached to the corresponding destination when providing the map information.

12. A map information providing system having a user terminal device, a map information providing device for providing map information of a destination a user wants, in response to a request from the user terminal device, and the Internet for connecting them with each other, in which
the user terminal device comprising:
means for gaining access to a home page opened on the Internet by a map information provider;
means for repeating, several times, an operation of entering and sending a retrieval condition of a destination on the home page and selecting a desired destination from the received destination candidate list information, and storing the selected destinations every time;
means for requesting the map information of the several destinations stored in the above from the map information provider; and
means for receiving and displaying the home page information and the map information, while
the map information providing device comprising:
means for registering a second destination which the map information provider originally selects, in addition to a first destination of a dealer who is under contract with the map information provider to be published on a map, as map information;
means for retrieving the map information according to the retrieval condition received from the user terminal device and sending the destination candidate list information to the user terminal device;
means for checking whether the several destinations include the second destination or not when the map information of the several destinations is requested by the user terminal device;
means for, when the above destinations include at least one and more second destinations as the result of the above check, notifying the user terminal device of the effect that the second destination is with a charge, and confirming a user's will to pay of the charge; and
means for performing billing processing and providing the map information of all the requested destinations when acceptance of the payment is confirmed by the user terminal device, and providing the map information of the destinations other than the second destination when refusal of the payment is confirmed by the user terminal device.

13. The map information providing system as set forth in claim 12, wherein
said map information providing means creates and provides the map information with a mark attached to the corresponding destination when providing the map information.

14. The map information providing system as set forth in claim 12, wherein
said map information providing means of the map information providing device further includes a function of creating and providing the map information including all the destinations on the same map when there is a request for two and more destinations requiring the map information, and
creates and provides the map information with a mark attached to the corresponding destination when providing the map information.

15. A map information providing system having a user terminal device, a map information providing device for providing map information of a destination a user wants, in response to a request from the user terminal device, and the Internet for connecting them with each other, in which
the user terminal device comprising:
means for gaining access to a home page opened on the Internet by a map information provider;
means for repeating, several times, an operation of entering and sending a retrieval condition of a destination on the home page and selecting a desired destination from the received destination candidate list information, and storing the selected destinations every time;
means for entering and sending a retrieval condition of a reference point on the home page, selecting a desired reference point from the received reference point candidate list information, and storing the same reference point;
means for requesting the map information of the several destinations and the reference point stored in the above from the map information provider; and
means for receiving and displaying the home page information and the map information, while
the map information providing device comprising:
means for registering a second destination which the map information provider originally selects, in addition to a first destination of a dealer who is under contract with the map information provider to be published on a map, as map information;
means for retrieving the map information according to the retrieval condition received from the user terminal device and sending the destination candidate list information and the reference point candidate list information to the user terminal device;
means for checking whether the several destinations include the second destination or not when the map information of the reference point and the several destinations is requested by the user terminal device;
means for, when the above destinations include at least one and more second destinations as the result of the above check, notifying the user terminal device of the effect that the second destination is with a charge, and confirming a user's will to pay of the charge; and
means for performing billing processing, and creating and providing the map information including all the requested destinations and reference point on the same map when acceptance of the payment is confirmed by the user terminal device, and creating and providing the map information including the reference point and the destinations other than the second destination on the same map when refusal of the payment is confirmed by the user terminal device.

16. The map information providing system as set forth in claim 15, wherein
said map information providing device creates the map information with a mark attached to the corresponding destination and reference point when creating the map information.

17. A map information providing method in which a map information providing device provides map information of a destination a user wants, in response to a request from a user terminal device, comprising the following steps of:
registering pay destinations and free destinations into the map information providing device in advance;
checking whether the requested destination is free of charge or with a charge when the map information of a destination is requested by the user terminal device;
providing the map information free of charge when the destination proves to be free as the result of the check;
notifying the user terminal device of this effect when the destination proves to be with a charge and confirming a user's will to pay for the charge; and
performing billing processing and providing the map information when a user accepts the payment, while
finishing a connection when a user refuses the payment.

18. A map information providing method in which a map information providing device provides map information of a destination a user wants, in response to a request from a user terminal device, comprising the following steps of:
registering pay destinations and free destinations into the map information providing device in advance;
checking whether the several destinations include the pay destination when the map information of several destinations is requested by the user terminal device;
notifying the user terminal device of this effect when the destinations include at least one and more pay destinations as the result of the check and confirming a user's will to pay for the charge; and
performing billing processing when a user accepts the payment and creating and providing the map information including all the requested destinations on the same map; while
creating and providing the map information including the destinations other than the pay destination on the same map when a user refuses the payment.

19. A map information providing method in which a map information providing device provides map information of a destination a user wants, in response to a request from a user terminal device, comprising the following steps of:
registering pay destinations and free destinations into the map information providing device in advance;
checking whether the several destinations include the pay destination when the map information of a reference point and several destinations is requested by the user terminal device;
notifying the user terminal device of this effect when the destinations include at least one and more pay destinations as the result of the check and confirming a user's will to pay for the charge; and
performing billing processing when a user accepts the payment, and creating and providing the map information including all the requested destinations and reference point on the same map; while
creating and providing the map information including the reference point and the destinations other than the pay destination on the same map when a user refuses the payment.

20. A map information providing program, which works a computer, for providing the map information of a destination a user wants, in response to a request from a user terminal device, comprising the functions of:
a function of registering a second destination which a map information provider originally selects, in addition to a first destination of a dealer who is under contract with a map information provider to be published on a map, as map information;
a function of checking whether the requested destination is the first destination or the second destination when the map information of a destination is requested by the user terminal device; and
a function of providing the map information free of charge when the destination proves to be the first destination as the result of the above check, and notifying the user terminal device of the effect that the second destination is with a charge, so to confirm a user's will to pay for the charge when the destination proves to be the second destination, when acceptance of the payment is confirmed by the user terminal device, performing billing processing and providing the map information, while when refusal of the payment is confirmed by the user terminal device, finishing a connection.

21. A map information providing program, which works a computer, for providing the map information of a destination a user wants, in response to a request from a user terminal device, comprising the functions of:
a function of registering a second destination which a map information provider originally selects, in addition to a first destination of a dealer who is under contract with the map information provider to be published on a map, as map information;
a function of checking whether the several destinations include the second destination or not when the map information of several destinations is requested by the user terminal device;
a function of, when the above destinations include at least one and more second destinations as the result of the above check, notifying the user terminal device of the effect that the second destination is with a charge, and confirming a user's will to pay of the charge; and
a function of performing billing processing, and creating and providing the map information including all the requested destinations on the same map when acceptance of the payment is confirmed by the user terminal device, and creating and providing the map information including the destinations other than the second destination when refusal of the payment is confirmed by the user terminal device.

22. A map information providing program, which works a computer, for providing the map information of a destination a user wants, in response to a request from a user terminal device, comprising the functions of:
a function of registering a second destination which a map information provider originally selects, in addition to a first destination of a dealer who is under contract with the map information provider to be published on a map, as map information;
a function of checking whether the several destinations include the second destination or not when the map information of a reference point and several destinations is requested by the user terminal device;
a function of, when the above destinations include at least one and more second destinations as the result of the above check, notifying the user terminal device of the effect that the second destination is with a charge, and confirming a user's will to pay of the charge; and
a function of performing billing processing, and creating and providing the map information including all the requested destinations and reference point on the same map when acceptance of the payment is confirmed by the user terminal device, and creating and providing the map information including the reference point and the destinations other than the second destination on the map when refusal of the payment is confirmed by the user terminal device.
